(19) United States
(12) Patent Application Publication
(10) Pub. No.: US 2012/0110365 A1
(43) Pub. Date: May 3, 2012

(54) METHOD FOR LOCKING FREQUENCY OF USB DEVICE AND USB FREQUENCY LOCKING DEVICE

(76) Inventors: Wen-Ger WONG, Hsin Chu City (TW); Kun-Chu Tsai, Hsin Chu County (TW)

(21) Appl. No.: 13/282,335

(22) Filed: Oct. 26, 2011

(30) Foreign Application Priority Data
Oct. 27, 2010 (TW) 099136644

(51) Int. Cl. G06F 1/06

(52) U.S. Cl. 713/501

(57) ABSTRACT

A method for locking the frequency of a USB device includes the following steps. Receive a USB data signal and generate multiple reference clock signals. Compare the frequency of the reference clock signals with a bit rate of the USB data signal to generate a control signal. Adjust the operating frequency of an output clock of the USB device according to the control signal.

### BACKGROUND OF THE INVENTION

a. Field of the Invention

The invention relates to a method for locking frequency, and particularly to a method for locking the operating frequency of an oscillator in a USB (universal serial bus) device.

b. Description of the Related Art

Typically, in a method for locking internal clock frequencies of a USB device, a clock output by an external crystal oscillator is used as a reference frequency, and a phase-locked loop is used to generate the internal clock. In case a reference frequency from an external crystal oscillator is not available, a specific data signal having a constant cycle or period (such as a start of frame or a keep alive signal) may serve as a reference frequency to provide a correct internal clock. In that case, a reference clock signal generated by an internal programmable oscillator is compared with the specific data signal to thereby generate the internal clock. As shown in FIG. 1, a conventional frequency locking device 100 includes a start-of-frame detector 102, a counter 104, a logic control unit 106 and a programmable oscillator 108. The start-of-frame detector 102 receives a data signal DATA of an incoming data stream and outputs a detection signal DET to the counter 104. The counter 104 calculates the constant period of the start of frame (SOF) between two adjacent frames and accumulates a value CNT. If the value CNT is larger than a predetermined value X (the value is determined by the counting frequency; for example, X=3750 when the counting frequency is 30 MHz), the logic control unit 106 outputs an adjusting signal CN to lower the operating frequency of the clock CLK of the programmable oscillator 108. On the contrary, if the value CNT is smaller than the value X, the operating frequency of the clock CLK of the programmable oscillator 108 is adjusted to be higher. However, according to the above method, the operating frequency of the clock CLK of the programmable oscillator 108 fails to be adjusted until the start of frame emerges. Therefore, the clock calibration rate fails to be further increased.

### BRIEF SUMMARY OF THE INVENTION

The invention provides a method and a device for locking the frequency of a USB device to overcome disadvantages of conventional designs, increase the clock calibration rate, and accurately lock clock frequency.

Other objectives, features and advantages of the invention will be further understood from the further technological features disclosed by the embodiments of the invention.

In order to achieve one or a portion of or all of the objects or other objects, one embodiment of the invention provides a method for locking frequency of a USB device. The method includes the following steps: receiving a USB data signal; generating a plurality of reference clock signals; comparing frequencies of the reference clock signals with a bit rate of the USB data signal to generate a control signal; and adjusting the operating frequency of an output clock of the USB device according to the control signal.

In one embodiment, the above comparison step includes: sampling the reference clock signals from the USB data signal to generate a phase state signal, wherein the reference clock signals have an identical frequency and different phase states; and generating the control signal according to the phase state signal.

In one embodiment, the above comparison step includes: sampling the USB data signal according to different phases of the reference clock signals to realize which two phases the transition time of the USB data signal is located between, wherein the reference clock signals have an identical frequency and different phase states; and generating the control signal according to the location of the transition time of the USB data signal.

In one embodiment, the above comparison step includes: providing a recovery clock signal and acquiring a first value by accumulating the recovery clock signal; selecting one of the reference clock signals and acquiring a second value by accumulating the selected reference clock signal; and comparing the first value with the second value to generate the control signal.

Another embodiment of the invention provides a USB frequency locking device. The USB frequency locking device includes a programmable oscillator, a comparing unit and a logic control unit. The programmable oscillator generates a plurality of reference clock signals. The comparing unit receives a USB data signal and the reference clock signals and compares frequencies of the reference clock signals with a bit rate of the USB data signal to generate a control signal. The logic control unit adjusts the operating frequency of an output clock according to the control signal.

According to the above embodiments, the frequency locking device calibrates the operating frequency of the programmable oscillator as soon as the data is received, without waiting for the emergence of a start of frame (SOF). Further, the calibration method is not influenced by period changes of the start of frame to thus achieve an accurate clock frequency. Therefore, the speed and accuracy of clock calibration are effectively increased.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a conventional device for locking clock frequency.

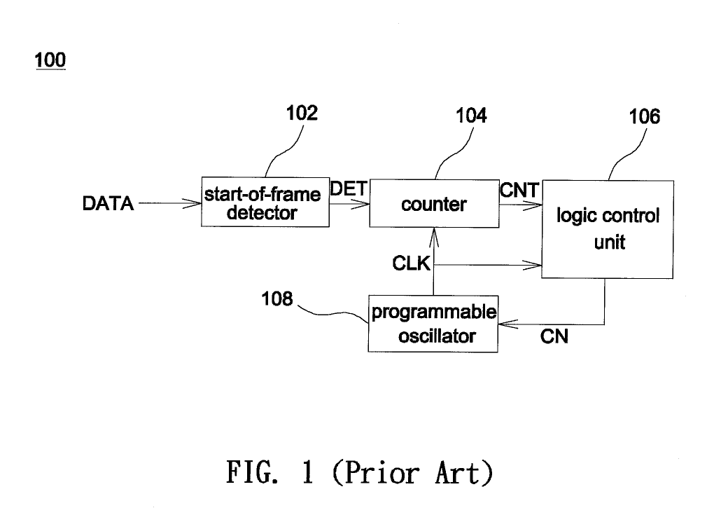

FIG. 2 shows a schematic diagram illustrating a method for locking clock frequency according to an embodiment of the invention.

FIG. 3 shows a schematic diagram illustrating a frequency detector according to an embodiment of the invention.

FIG. 4 shows a schematic diagram illustrating signal sampling waveforms and phase states in a frequency locking method according to an embodiment of the invention.

FIGS. 5 and 6 show schematic diagrams illustrating phase state changes in a frequency locking method according to an embodiment of the invention.

FIG. 7 shows a schematic diagram illustrating a circuit architecture for implementing a frequency locking method according to another embodiment of the invention.

FIG. 8 shows a schematic diagram illustrating an oversampling unit according to an embodiment of the invention.

FIG. 9 shows a schematic diagram illustrating a circuit architecture for implementing a frequency locking method according to another embodiment of the invention.

FIG. 10 shows a schematic diagram illustrating a circuit architecture for implementing a frequency locking method according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

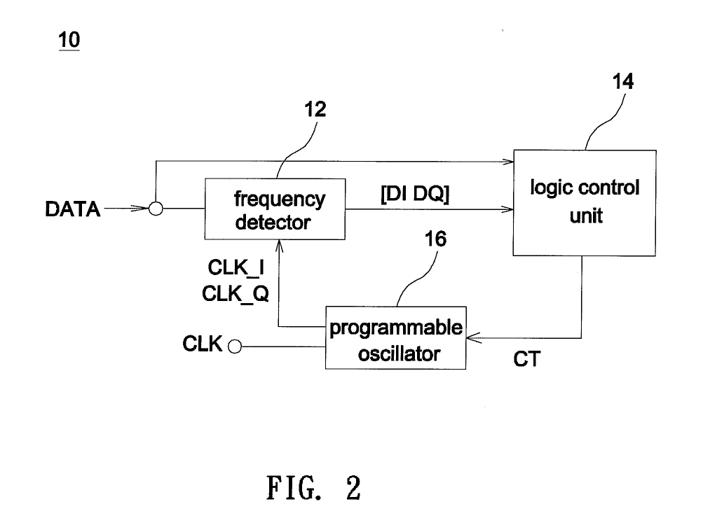

As shown in FIG. 2, a circuit architecture 10 for implementing a frequency locking method according to an embodiment of the invention includes a frequency detector 12, a logic control unit 14 and a programmable oscillator 16. Referring to FIG. 2, the programmable oscillator 16 provides at least two reference clock signals CLK_I and CLK_Q. The frequencies of the two reference clock signals are the same, and a phase difference between the reference clock signal CLK_I and the reference clock signal CLK_Q may be, for example, π/2. The programmable oscillator 16 may be, for example, a RLC oscillator or a CMOS oscillator. The programmable oscillator 16 may be formed by a plurality of single-type or multi-type oscillators connected with each other in series. The frequency detector 12 uses the data signal DATA to sample the reference clock signals CLK_I and CLK_Q and provides a phase state signal [DI DQ] for the logic control unit 14 according to sampling results. The logic control unit 14 controls the programmable oscillator 16 according to the phase state signal [DI DQ] to adjust the operating frequency of an oscillator clock CLK.

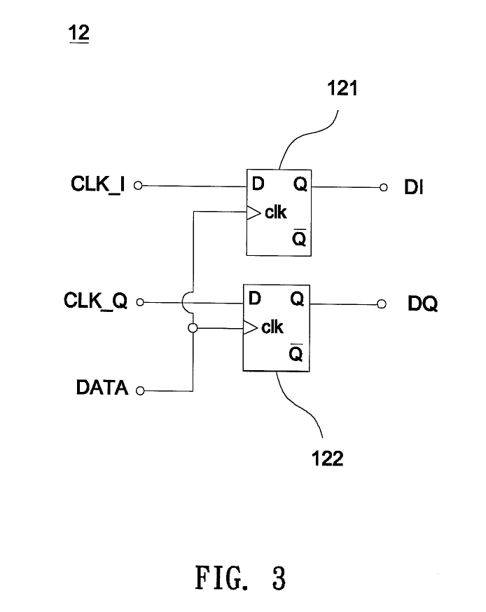

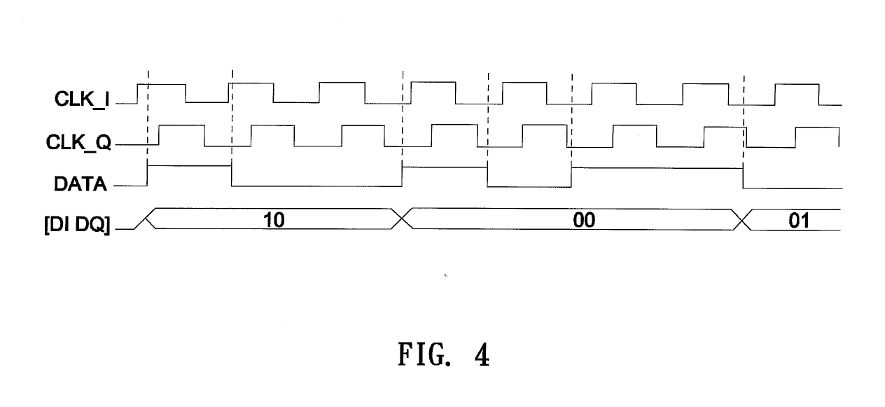

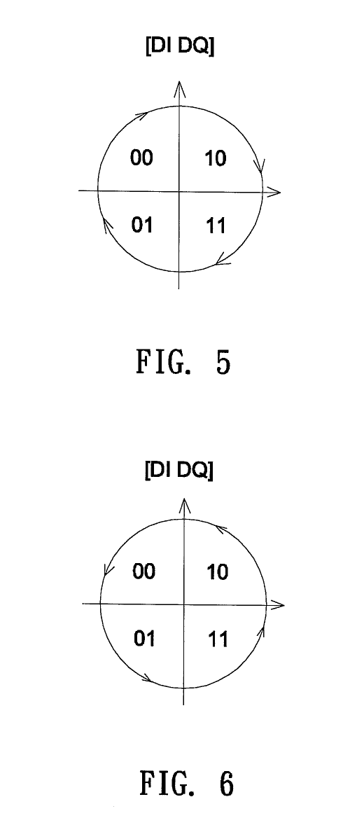

FIG. 3 shows a schematic diagram illustrating a frequency detector according to one embodiment of the invention. In this embodiment, the frequency detector 12 includes a first D-type flip-flop 121 and a second D-type flip-flop 122. Each of the D-type flip-flops 121 and 122 is an edge-triggered flip-flop, such as rising edge triggered, falling edge triggered, or double-edge triggered. Herein, the D-type flip-flops 121 and 122 are exemplified as double-edge triggered. The data signal DATA serves as a trigger signal, the input signal of the first D-type flip-flop 121 is CLK_I, and the input signal of the second D-type flip-flop is CLK_Q. When an edge of the data signal DATA emerges, the first D-type flip-flop 121 outputs the level of CLK_I to provide a phase output signal DI and continues to latch on until a next edge of the data signal DATA emerges. The second D-type flip-flop 122 outputs the level of CLK_Q to provide a phase output signal DQ and continues to latch on until a next edge of the data signal DATA emerges. Please also refer to a waveform diagram shown in FIG. 4. For example, the first time the data signal DATA in the USB device emerges to have a high level, the reference clock signal CLK_I in response to the high-level edge of the data signal DATA is at a high level, and the reference clock signal CLK_Q is at a low level. Thus, the first phase output signal of the first D-type flip-flop 121 is [DI]=1, and the second phase output signal of the second D-type flip-flop 122 is [DQ]=0. Thus, before a succeeding high-level edge of the data signal DATA emerges, the phase state signal [DI DQ]=[10]. Then, according to waveform changes of the two reference clock signals CLK_I and CLK_Q, the phase state signal [DI DQ] is changed to [00]-[01]-[11]-[10] . . . , sequentially. Since the frequency detector 12 may detect a current phase state of the data signal DATA, the phase state remains fixed as the frequency is fixed. In comparison, the phase state varies as the frequency changes. Particularly, the phase state varies in a manner depending upon whether the frequency is too high or too slow. For example, according to the above embodiment, when the frequency is too high, the phase state signal [DI DQ] shown in FIG. 5 is changed as [00]-[10]-[11]-[01]-[00] . . . , and the logic control unit 14 outputs a control signal CT to decrease the operating frequency of the clock CLK of the programmable oscillator 16. On the contrary, according to the above embodiment, when the frequency is too slow, the phase state signal [DI DQ] shown in FIG. 6 is changed as [00]-[01]-[11]-[10]-[00] . . . , and the logic control unit 14 outputs a control signal CT to increase the operating frequency of the clock CLK of the programmable oscillator 16. Taking the reference clock signals CLK_I and CLK_Q as one example, the phase difference of the reference clock signals CLK_I and CLK_Q is not equal to π. If the phase difference is π, the phase state signal [DI DQ] is only divided into two blocks [01] and [10], and the logic control unit 14 fails to use only two output phase states to determine changes in frequency. By the design of the above embodiment, the frequency locking device 10 calibrates the operating frequency of the programmable oscillator 16 as soon as the data is received, without waiting for the emergence of a start of frame (SOF). Further, the calibration method is not influenced by period changes of the start of frame to thus achieve an accurate clock frequency. Therefore, the speed and accuracy of clock calibration are effectively increased.

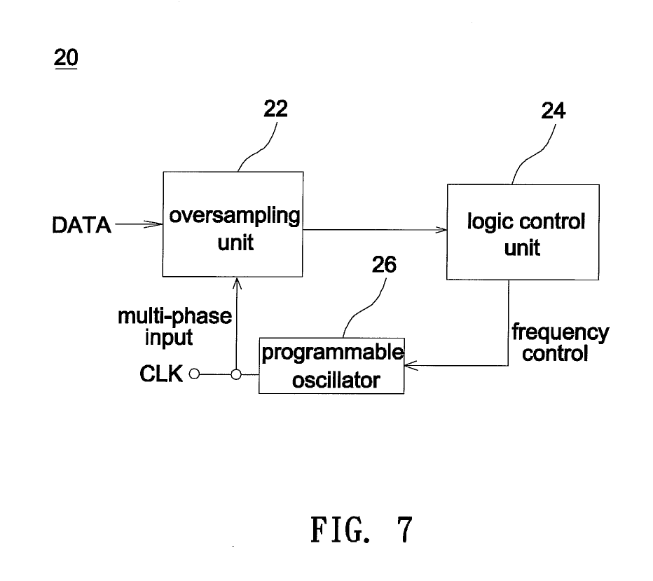

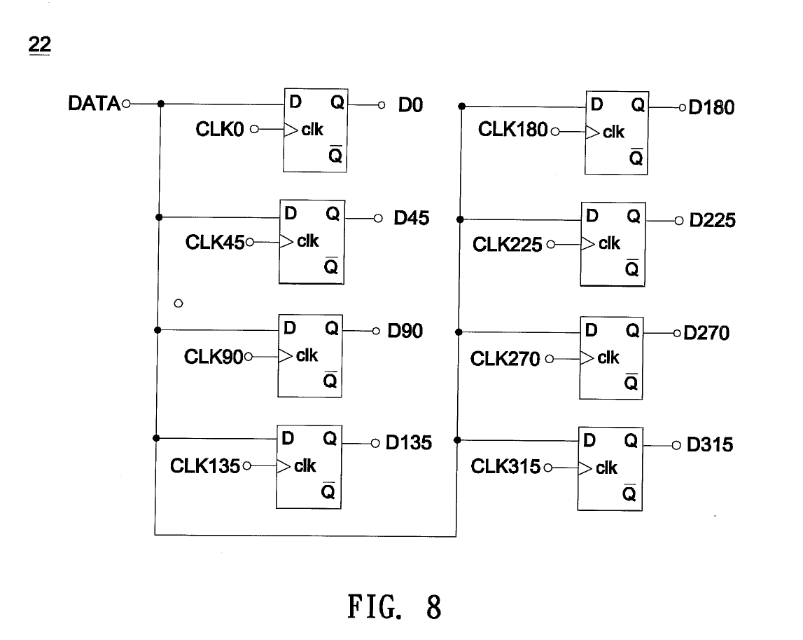

FIG. 7 shows a schematic diagram illustrating a circuit architecture for implementing a frequency locking method according to another embodiment of the invention. As shown in FIG. 7, the circuit architecture 20 includes an oversampling unit 22, a logic control unit 24 and a programmable oscillator 26. In this embodiment, the programmable oscillator 26 may be a multiple-phase oscillator. The programmable oscillator 26 generates a plurality of reference clock signals, and each reference clock signal has a phase difference of 360/N degrees with each other, where N is a positive integer larger than or equal to 3 and may be varied according to actual demands. For example, referring both FIG. 7 and FIG. 8, the programmable oscillator 26 generates eight (N=8) reference clock signals CLK0, CLK45, CLK90, CLK135, CLK180, CLK225, CLK270 and CLK315 having a phase difference of 45 degrees with each other. The oversampling unit 22 uses the reference clock signals to sample the data signal DATA to realize which two phases the transition time of the data signal DATA within a normal adjustment period is located between. Then, the oversampling unit 22 outputs the two phases the transition time is located between. For example, if the transition time is located between phases CLK45 and CLK90, an output phase state signal [D0 D45 D90 D135 D180 D225 D270 D315] is [1 1 0 0 0 0 0 0] or [0 0 1 1 1 1 1 1]. If the bit rate of the data signal DATA is changed, the selected two phases are changed over time. When the selected two phases are changed, the logic control unit 24 changes the operating frequency of the programmable oscillator 26 according to a current phase state signal [D0 D45 D90 D135 D180 D225 D270 D315]. Therefore, the operating frequency of the clock CLK of the programmable oscillator 26 may match the bit rare of the data signal DATA and is locked up.

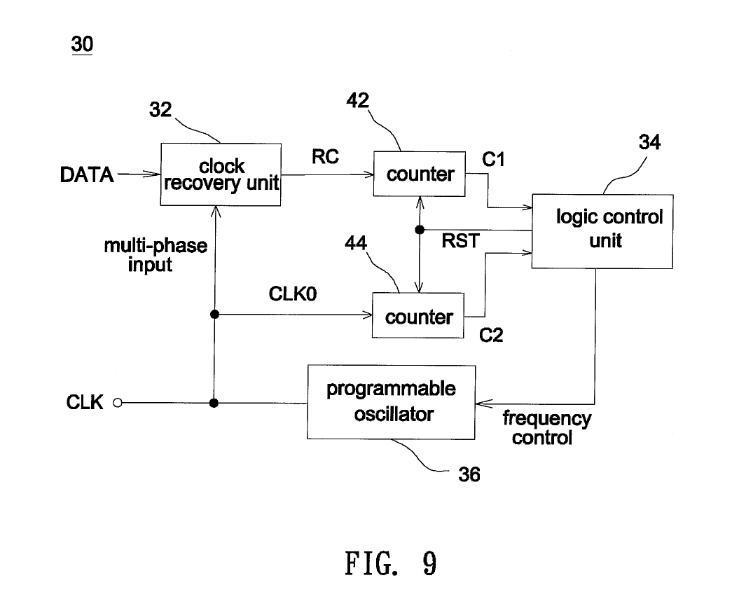

FIG. 9 shows a schematic diagram illustrating a circuit architecture for implementing a frequency locking method according to another embodiment of the invention. As shown in FIG. 9, a recovery clock RC is generated when the data signal DATA of the circuit architecture 30 passes through the clock recovery unit 32. The recovery clock RC is a clock signal. When the data signal DATA is under a transition state, a clock phase on which a transition from a low level to a high level is made is output. Therefore, a recovery clock RC having an average output frequency equal to the data bit rate is generated. A value C1 is accumulated by having the recovery clock RC pass through a first counter 42. In addition, one of the multiple-phase clocks CLK0-CLK315 outputted by the programmable oscillator 36 may be selected to pass through a second counter 44 so as to accumulate a value C2. The values C1 and C2 are compared with each other for the following calibration process. When the difference of the two values C1 and C2 is larger than X (for example, X≧2), the logic control unit 34 adjusts the operating frequency of the programmable oscillator 36 and outputs a reset signal RST to reset the counters 42 and 44. For example, when (C1−C2)>X, it indicates that the bit rate of the data signal DATA is higher than the frequency of the reference clock CLK, and thus the operating frequency of the programmable oscillator 36 is adjusted to be higher. On the contrary, if C2>C1, it indicates that the frequency of the reference clock CLK is higher than the bit rate of the data signal DATA, and thus the operating frequency of the programmable oscillator 36 is adjusted to be slower.

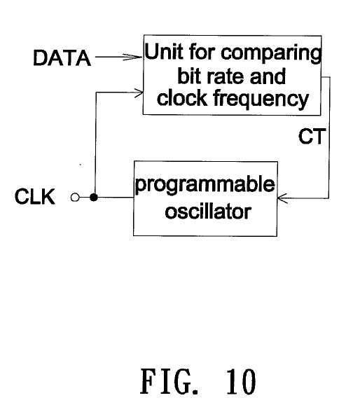

In conclusion, from the above embodiments, a method for locking frequency is provided below. The method may be applied to a USB (universal serial bus) device and includes the following steps: receiving a USB data signal and a plurality of reference clock signals; comparing frequencies of the reference clock signals with a bit rate of the USB data signal to generate a control signal; and adjusting the operating frequency of an output clock according to the control signal. An exemplified circuit architecture of the method for locking frequency is shown in FIG. 10.

In the above embodiments, the phase change of the data signal DATA is used as a basis for frequency calibration. Note a correct criterion for frequency calibration is that an accumulated phase difference between two adjacent edges of the data signal DATA is smaller than 180 degrees. If the phase difference between two adjacent edges of the data signal DATA is larger than 180 degrees, the phase change serving as a basis for frequency calibration is located in an abnormal period, and thus the logic control unit may incorrectly adjust the frequency of the reference clock CLK. Specifically, the logic control unit may mistakenly subtract 360 degrees from the phase difference of two adjacent edges to reverse the phase difference. Therefore, when the accumulated phase difference of two adjacent edges of the data signal DATA is larger than 180 degrees, the frequency calibration may be incorrect.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated.

What is claimed is:

1. A method for locking the frequency of a USB (universal serial bus) device, comprising:
receiving at least one USB data signal;
generating a plurality of reference clock signals;
comparing frequencies of the reference clock signals with a bit rate of the USB data signal to generate a control signal; and
adjusting the operating frequency of an output clock of the USB device according to the control signal.

2. The method as claimed in claim 1, wherein the comparison step comprises:
sampling the reference clock signals from the USB data signal to generate a phase state signal, wherein the reference clock signals have an identical frequency and different phase states; and
generating the control signal according to the phase state signal.

3. The method as claimed in claim 2, wherein a phase difference between two USB data signals having adjacent phases is smaller than 180 degrees.

4. The method as claimed in claim 2, wherein the USB data signal is a trigger signal for at least two flip-flops, and the reference clock signals are input signals of the flip-flops.

5. The method as claimed in claim 2, wherein the phase state signal is composed of an output signal generated by at least two flip-flops.

6. The method as claimed in claim 1, wherein the comparison step comprises:
sampling the USB data signal according to different phases of the reference clock signals to realize which two phases the transition time of the USB data signal is located between, wherein the reference clock signals have an identical frequency and different phase states; and
generating the control signal according to the location of the transition time of the USB data signal.

7. The method as claimed in claim 6, wherein the reference clock signals have a phase difference of 360/N degrees (N is a positive integer larger than or equal to 3) with each other, and a phase difference between two USB data signals having adjacent phases is smaller than 180 degrees.

8. The method as claimed in claim 1, wherein the comparison step comprises:
providing a recovery clock signal and acquiring a first value by accumulating the recovery clock signal;
selecting one of the reference clock signals and acquiring a second value by accumulating the selected reference clock signal; and
comparing the first value with the second value to generate the control signal.

9. A USB frequency locking device, comprising:
a programmable oscillator for generating a plurality of reference clock signals;
a comparing unit for receiving at least one USB data signal and the reference clock signals and comparing frequencies of the reference clock signals with a bit rate of the USB data signal to generate a control signal; and
a logic control unit for adjusting the operating frequency of an output clock according to the control signal.

10. The USB frequency locking device as claimed in claim 9, wherein the comparing unit comprises a frequency detector.

11. The USB frequency locking device as claimed in claim 9, wherein the comparing unit comprises an oversampling unit.

12. The USB frequency locking device as claimed in claim 9, wherein the comparing unit comprises a clock recovery unit and a plurality of counters.

13. The USB frequency locking device as claimed in claim 9, wherein the programmable oscillator comprises an RLC oscillator or a CMOS oscillator.

14. The USB frequency locking device as claimed in claim 9, wherein the programmable oscillator is formed by a plurality of single-type or multi-type oscillators connected with each other in series.
